(19) United States
(12) Patent Application Publication
(10) Pub. No.: US 2016/0023427 A1
(43) Pub. Date: Jan. 28, 2016

(54) NANOMATERIAL BASED FABRIC REINFORCED WITH PREPREG METHODS, AND COMPOSITE ARTICLES FORMED THEREFROM

(71) Applicants: Dante R. Guerra, Columbus, OH (US); Jesse M. Guerra, Columbus, OH (US)

(72) Inventors: Dante R. Guerra, Columbus, OH (US); Jesse M. Guerra, Columbus, OH (US)

(73) Assignee: Niles Nanofabrix, Niles, OH (US)

(21) Appl. No.: 13/903,480

(22) Filed: May 28, 2013

Related U.S. Application Data
(60) Provisional application No. 61/791,465, filed on Mar. 15, 2013.
(60) Provisional application No. 61/652,612, filed on May 29, 2012.

(51) Int. Cl. B32B 5/02; B32B 5/26; B32B 29/02; B32B 27/12; B05B 7/16; C08K 3/00; C08K 5/00; B05D 1/18; B05D 1/02; C08J 5/24; B32B 15/14

(52) U.S. Cl. CPC B32B 5/028; C08J 5/24; B32B 5/26; B32B 5/022; B32B 5/024; B32B 29/02; B32B 27/12; B32B 15/14; C08K 3/0008; C08K 5/0008; B05D 1/18; B05D 1/02; B05B 7/1693; C08J 2300/22; C08J 2300/24; B32B 2305/076; B32B 2307/202

(57) ABSTRACT

A nanoparticle sheet is formed by spray deposition of a nanoparticle solution, onto a carrier. The resulting nanoparticle sheet is then prepregged by applying resins to the formed nanoparticle sheet. The resulting prepregged nanoparticle sheet is then used to provide a unique component in a wide variety of composite laminated products.

### PRIORITY DATA

The present utility application is based upon U.S. Provisional Patent Application No. 61/652,612, filed on May 29, 2012, and U.S. Provisional Patent Application No. 61/791,465, filed on Mar. 15, 2013.

### FIELD OF THE INVENTION

The present invention relates generally to the field of composite materials including nanomaterial structures. In particular, the present invention is directed to a new method and system for manufacturing nanoparticle or nanomaterial sheets, and reinforcing them to render them suitable for a variety of uses, especially as part of composite materials, or laminates.

### BACKGROUND OF THE INVENTION

Polymer composite materials have been widely used in the aerospace, transportation, and energy generation industries due to their superior specific strength, lower density, higher corrosion resistance, and generally lower cost when compared to monolithic metal alloys. Nevertheless, certain physical properties, such erosion resistance and desired electrical conductivity levels are still lower than those of their metal counterparts.

State of the art research and development efforts to improve the erosion resistance and electrical conductivity of light-weight, composite materials has focused on the adaptation of nanomaterials such as Carbon Nanotubes (CNTs), Carbon Nanofibers (CNFs), and nanographites. The most widely used method of incorporating these nanomaterials is to disperse them into a desired polymer matrix by means of high shear mixing, as in the case of thermosets, or twin screw compounding, as in the case of thermoplastics. Unfortunately, incorporating nanomaterials by these conventional techniques results in a loading maximum beyond which there is agglomeration and loss of desired properties.

Nanomaterials based non-woven fabrics (NNWF) have excellent erosion and wear resistance as well as electrical conductivity characteristics suitable for applications, which include but are not limited to de-icing/anti-icing, EMI shielding, ESD protection, lightning strike protection, and solid particle erosion protection. As such, NNWF is particularly appropriate for many aerospace security and communications uses.

Unfortunately, structures made of nanomaterials are extremely difficult to manufacture in sufficient bulk to obtain desirable sizes and configurations. Likewise, nanomaterials structures are often very fragile, and difficult to manipulate for inclusion into composite products, such as laminated sheets. Nanomaterial structures with desirable characteristics can be extremely expensive to manufacture, and very often cannot be produced in sufficient quantities to be useful in many applications, such as large aircraft panels.

Conventional nanomaterials fabrication technologies are cost-prohibitive and not commercially viable due to the limitations of their fabrication processes. Additionally, conventional nanomaterial-based films are all in a fragile dry form, necessitating special handleability and safety protocols. Conventional NNWF structures, especially sheets or films, do not admit to being prepregged post-production as a secondary step in the overall fabrication of a reinforced nanomaterials sheet.

Consequently, there exists a need for a system and a process for using that system to produce large amounts of nanomaterial structures, such as sheets. The process must include arrangements for handling the normally fragile nanomaterial structures, and conditioning them for future use in composite products. The method for protecting the nanomaterial structures must be comprehensive, and must take advantage of the desirable characteristics of the nanoparticle material. Further, the overall results of the system must be a structure with desirable characteristics, such as those required of composite materials in a number of industries, such as aerospace.

### SUMMARY OF THE INVENTION

It is a primary object of the present invention to optimize the use of nanoparticle or nanomaterial structures in the manufacture of composite structures, such as laminates.

It is another object of the present invention to provide a manufacturing process that can produce non-woven, nanoparticle sheets in a wide range of sizes and configurations.

It is a further object of the present invention to provide a manufacturing system that is more efficient than conventional systems for manufacturing nanoparticle sheets, and produces less waste in doing so.

It is an additional object of the present invention to provide a reinforced nanoparticle sheet that admits to handling and facilitates use in composite structures.

It is still another object of the present invention to provide a manufacturing process having a desired range of nanomaterial loadings, and that facilitates efficient manufacture of both nanomaterial-based woven fabric (NWF) and nanomaterial-based non-woven fabric (NNWF) materials.

It is again a further object of the present invention to provide a low-cost mass-production-scalable system to enhance the performance of composites, such as laminates.

It is still an additional object of the present invention to provide a manufacturing system and end product which can enhance the performance of nanoparticle structures, including improved erosion resistance and electrical conductivity, as well as other desirable properties.

It is yet another object of the present invention to provide a manufacturing process that overcomes the limitations of conventional prepregging techniques.

It is yet a further object of the present invention to provide a system for manufacturing nanoparticle structures, such as sheets or films, using a wide variety of different manufacturing options for wide range of end products.

It is a again an additional object of the present invention to provide a reinforced nanoparticle sheet that can be used to enhance laminates or other composite structures, employing a wide range of additional materials.

It is still a further object of the present invention to provide a manufacturing system that reduces possible damage to nanoparticle structures.

These and other goals and objects of the present invention are achieved by a composite structure having at least one prepregged nanoparticle structure wherein resin is infused in the nanoparticle structure while individual nanoparticles maintain contact with each other within the resin matrix.

In another embodiment of the present invention, a process for manufacturing a nanoparticle structure is provided where the process includes the steps of forming a nanoparticle dispersion in a solvent. Next, at least a portion of the nanoparticle dispersion is deposited on a support structure. Finally, the solvent is removed from the deposited portion of the nanoparticle dispersion so as to form a nanoparticle sheet on the support structure.

In another embodiment of the present invention a method of prepregging a nanoparticle structure includes forming a finished nanoparticle structure, and then impregnating the nanoparticle structure with at least one of a resin or polymer.

In a further embodiment of the present invention a system is provided for manufacturing nanoparticle structures. This system includes at least one mixing portion to produce a dispersion of nanoparticles in a solvent, Next, at least part of the nanoparticles in the solvent is sprayed to deposit the dispersion on an external support. Then, that part of the nanoparticle dispersion that is not deposited is recirculated back to the mixing portion.

### BRIEF DESCRIPTION OF THE DRAWINGS

FIG. 1 is a generalized flow diagram depicting a combined process for manufacturing reinforced nanoparticle structures.

FIG. 2 is a schematic diagram depicting physical system for one prepregging operation.

FIG. 3 is a schematic diagram depicting a second prepregging operation.

FIG. 4 is a schematic diagram depicting a third prepregging operation.

FIGS. 5-25 depict cross-sectional views of various types of materials used to form a variety of different composite structures.

FIG. 26 is a schematic of a system to spray deposit nanoparticle sheets.

FIG. 27 is a schematic diagram of a cross-sectional view of a nanomaterial sheet made using conventional manufacturing techniques.

FIG. 28 is a schematic of a cross-sectional view of the nanomaterial sheet of the present invention.

### DETAILED DESCRIPTION OF THE PREFERRED EMBODIMENT

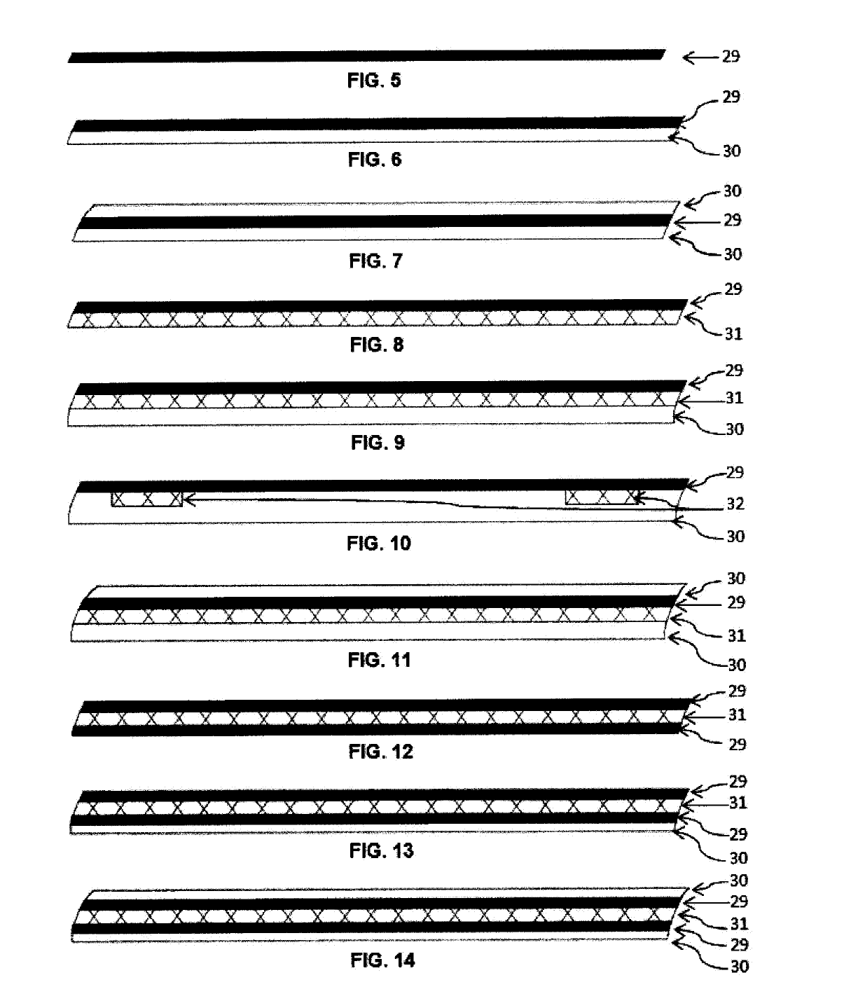

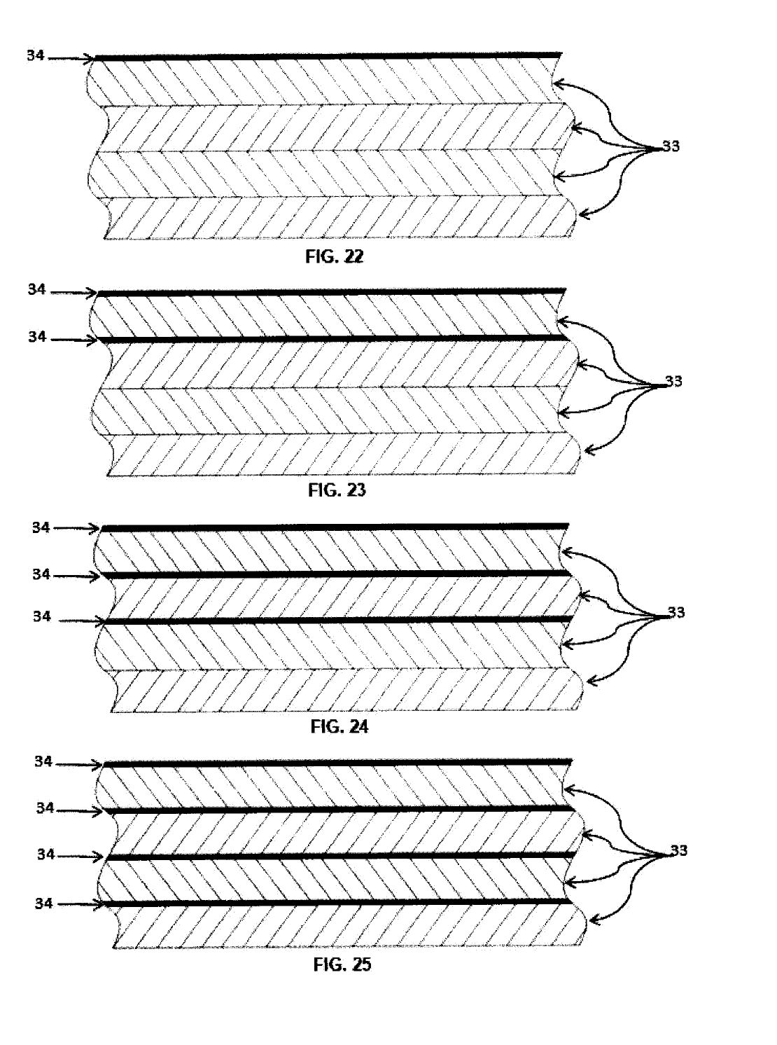

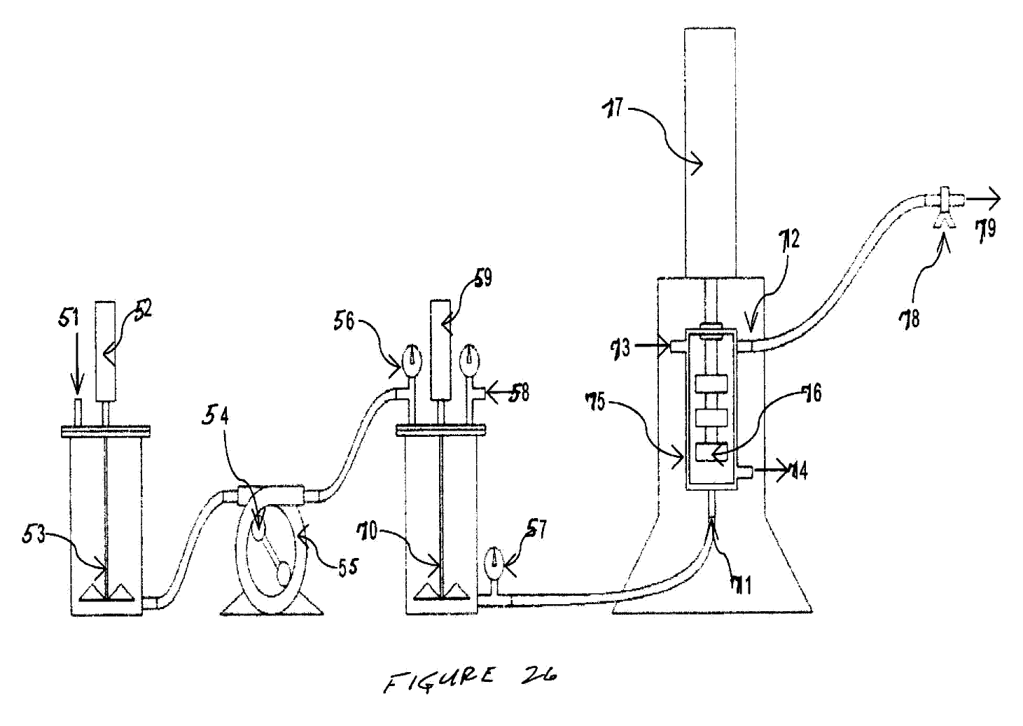

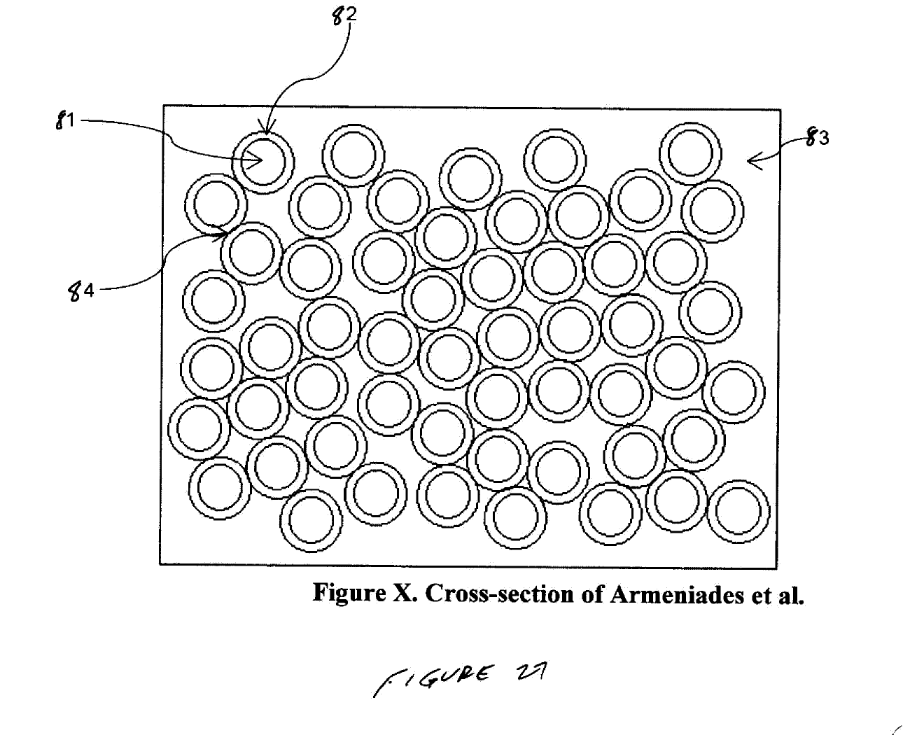

The present invention has two manufacturing aspects which are preferably integrated into the same manufacturing process. The first aspect is novel manufacture of a nanoparticle sheet using a continuous manufacturing cycle (as opposed to conventional “batch” methods). The use of spray deposition in manufacturing nanoparticle sheets permits large, non-woven (NNWF) structures to be quickly and efficiently manufactured. Because the resulting nanoparticle structures are porous and “fluffy”, they are reinforced by prepregging to create a structure that can be handled and used in a wide variety of new composite laminates (such s those depicted in FIGS. 5-25). The prepregged nanoparticle sheet constitutes a new product, which can be used to create a wide variety of new composite laminates.

It should be noted that while the present invention is particularly applicable to NNWF's, due to the fragility of such structures, the present invention can also be applied to the more robust woven nanomaterial products (NWF). It should also be noted that the prepregged nanoparticle sheet can also be reinforced with various types of fibers (including but not limited to woven, nonwoven, stitch, filament, yarn, unidirectional, and chalk) before the prepregging process is conducted, or even after the prepregging process is conducted. This a conventional reinforcing technique that can be added to the inventive aspects of the novel manufacturing process and novel nanoparticle product (preferably in sheet or film form).

Referring to FIG. 1, the NNWFs are generally produced following a fabrication scheme generally outlined in the flow diagram of FIG. 1. The text descriptions that are contained in the boxes are specific processes within the fabrication scheme, whereas the text descriptions that are not contained in the boxes are ingredients that are added to the fabrication scheme at different stages. The arrows indicate the flow of actions within the sequence.

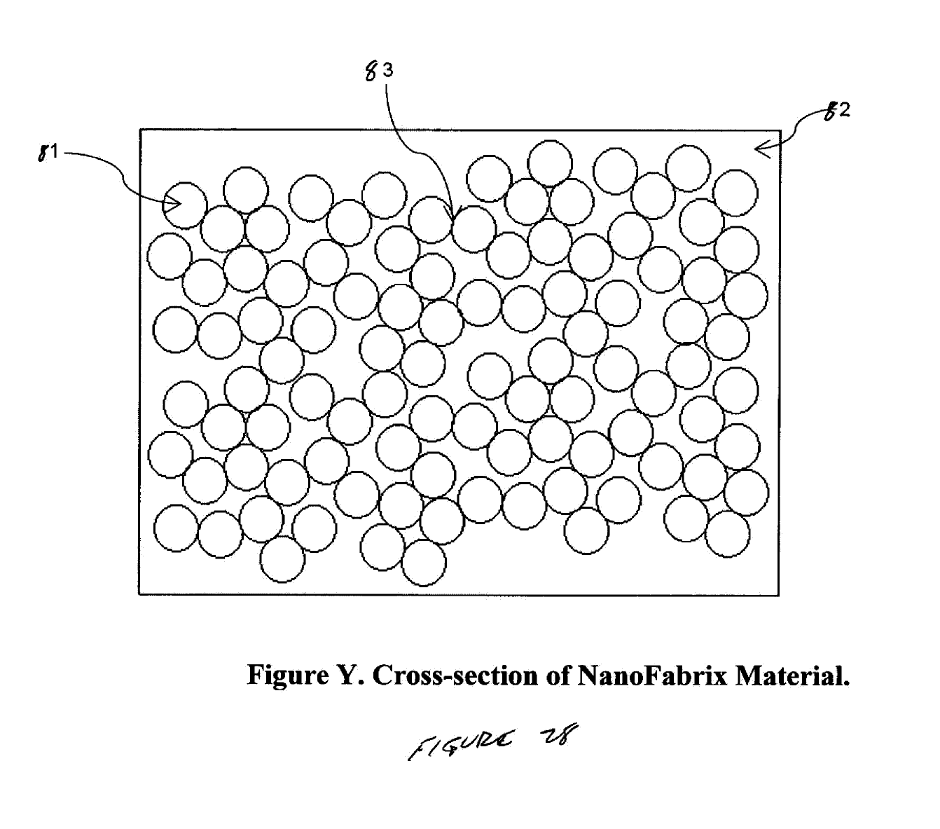

The flow diagram of FIG. 1 is a basic outline of a novel nanoparticle structure manufacturing process. The basic system for spray deposition of the nanoparticle structure is found in FIG. 26, and the description of the process and the various components is provided infra.

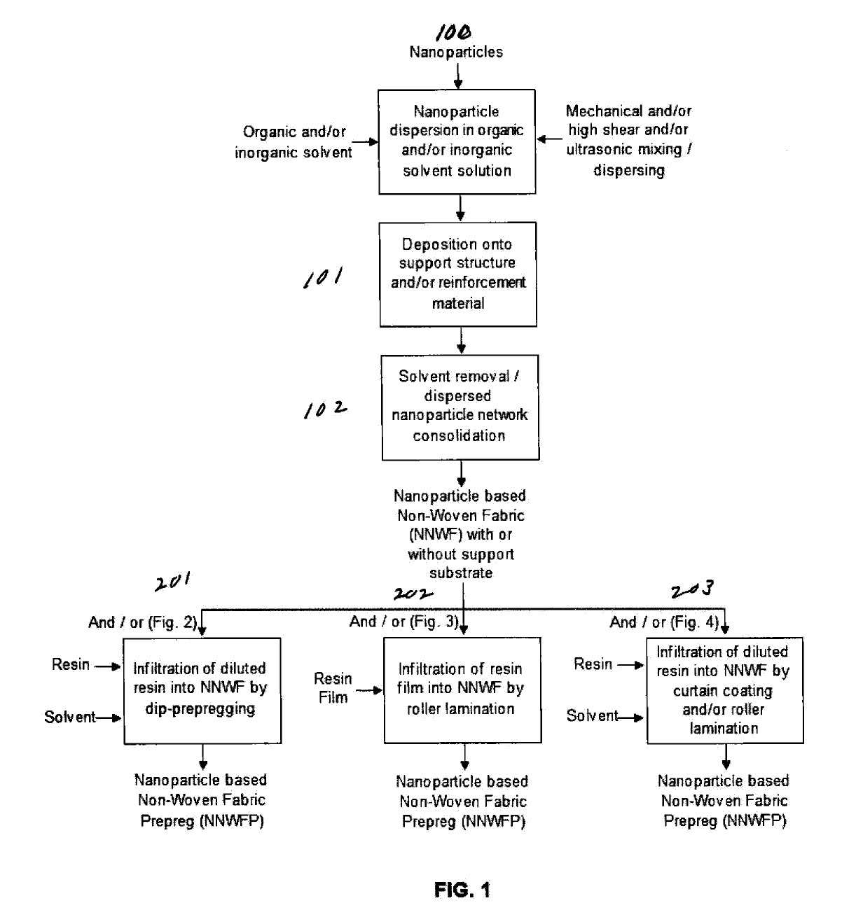

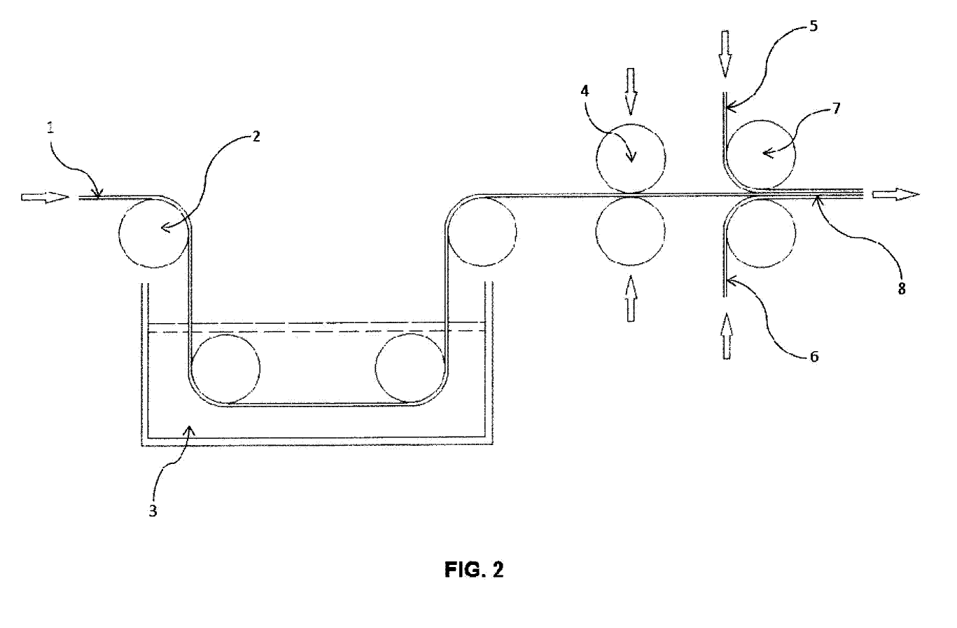

In FIG. 1, at step 100, nanoparticles are dispersed in organic or inorganic solvent to form a solution. Various mixing techniques can be used. At step 101, the nanoparticle solution is spray deposited onto a support structure. This structure can consist of a wide range of materials as will be described infra, the support or substrate can be any of a wide range of materials, having a number of different functions. At step 102, the solvent is removed to complete the consolidation of the non-woven nanoparticle network. Usually this is done by evaporation. However, other techniques can be used. The nanoparticle sheet is then reinforced using one of the prepregging techniques designated 201, 202, and 203. A more elaborate description of each of these techniques is described infra with respect to FIGS. 2-4.

However, the final product, preferably a nanoparticle sheet requires additional processing before it can be used in any practical sense in one of the aforementioned applications in which nanoparticle structures are desirable. This process is entirely novel with regard to nanoparticle structures and includes the use of prepregging using selected resin products. Further, the method and system for applying the method are unique since nanoparticle structures are not prepregged in the conventional art. Thin nanoparticle structures are too fragile for conventional techniques.

A number of prepregging techniques are suggested in the flow diagram of FIG. 1. Various processing systems for carrying out the various prepregging techniques 201, 202, 203 are depicted in FIGS. 2, 3, and 4, respectively. Because of the fragility of the nanoparticle sheets manufactured by the system and process of FIG. 26, special techniques must be used to handle the nanoparticle sheets. For example, the prepregging process is preferably done as soon as the solvent is fully dispersed and the nanoparticle network fully consolidated. This means that the prepregging work preferably begins immediately in the place where the nanoparticle spray deposition has been carried out. In effect the prepregging operation is a second and subsequent operation of the overall manufacturing process of the reinforced nanoparticle sheets.

There are a number of different steps that can be used to protect the nanoparticle sheets and prepare them for the full prepregging processes described with respect to FIGS. 2, 3 and 4. One technique includes the spraying of a binder, such as a resin, into the freshly manufactured nanoparticle sheet. This will serve to strengthen the sheet so that it might be handled by other means. However, this technique can compromise the desired resin level of the final product, and so is often not desirable.

Other techniques for handling the sheet as soon as the nanoparticle network is fully consolidated is the use of a transport, substrate support or backing upon which the nanoparticle sheets can be formed. This can be used to convey the nanoparticle sheet to another part of the prepregging system, such as depicted in FIGS. 2, 3, and 4. If a substrate or backing is used, it can accompany the nanoparticle sheet through the entire prepregging process, or can be removed as soon as the nanoparticle sheet has achieved sufficient tensile strength to be handled.

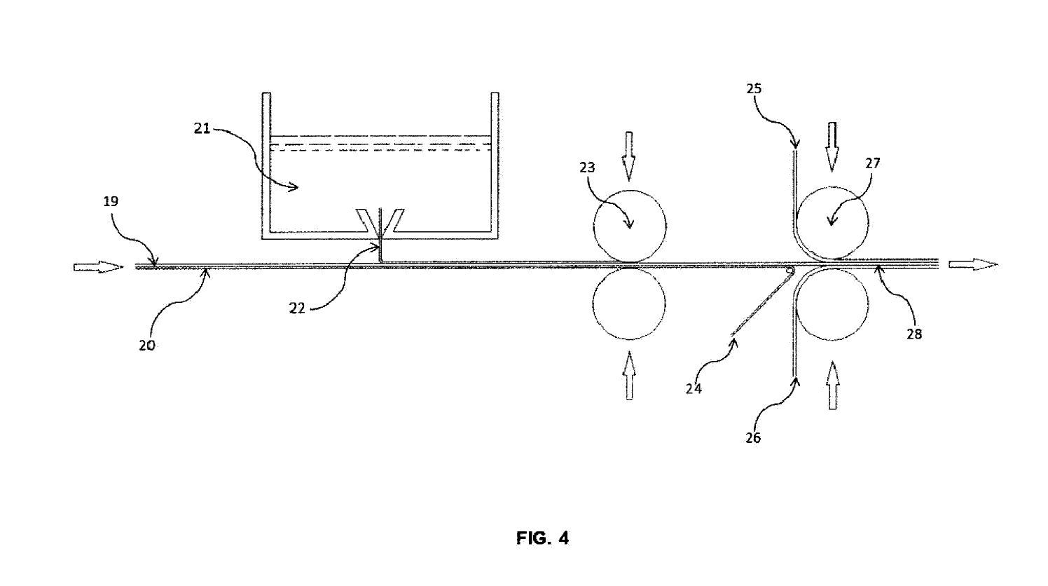

Other prepregging techniques, such as that depicted in FIG. 4 provides a layer of resin to serve as a support for a nanoparticle sheet as part of overall prepregging process it should be noted that the double laminations process as depicted in FIG. 4 it is roller pressure from five to sixty pound per square inch, depending upon the precious nanoparticle sheet and polymer being used. Temperatures might range from 100 to 350 degrees Fahrenheit, depending upon the exact nanomaterial sheet and the polymers being used for prepregging.

Because of fragility or the freshly formed nanoparticle sheet, it is crucial that prepregging take place in immediately. This allows the sheet to be formed virtually as a film, which mitigates against transport of the nanoparticle sheet. Should a nanoparticle sheet be conventionally formed to a sufficient density to be easily handled for transfer to another processing area then the sheet will lose a certain amount of its porosity. This makes prepregging more difficult and far less effective. Once a polymer has properly permeated the nanoparticle sheet, then pressure rollers and a bleeder ply will aid in removing excess resin by squeezing and absorbing the resin out of the prepregged sheet to achieve the desired fiber volume fraction and resin content. This immediate prepregging process of a nanoparticle material permits the exact prepregging to achieve the desired constituency of the prepregged nanoparticle sheet.

The bleeder ply is constituted two or more materials or films. The first film which would be in contact with the nanoparticle material sheet has small perforations in an evening distributed pattern which allows resin to follow through these perforations. The second layer is comprised of a “felt” or coarse material that absorbs the excess resin a possible third layer might also be used, and includes an additional perforated polymer film.

Likewise, the laminated products depicted in FIGS. 5-25 are also part of the overall process of forming a very fragile (fluffy) nanoparticle sheet, prepregging the nanoparticle sheet and placing it in lamination with other materials to form the final product. Because the nanoparticle sheets have vastly greater surface areas (due to the nature of nanoparticle structures), this makes the prepregging of the nanoparticle sheet far different than prepregging of conventional products such as that used in the manufacture of fiberglass. Conventional prepregging techniques if applied to nanoparticle sheets, would most likely destroy the sheets, and/or fail to properly prepreg the nanoparticle sheet.

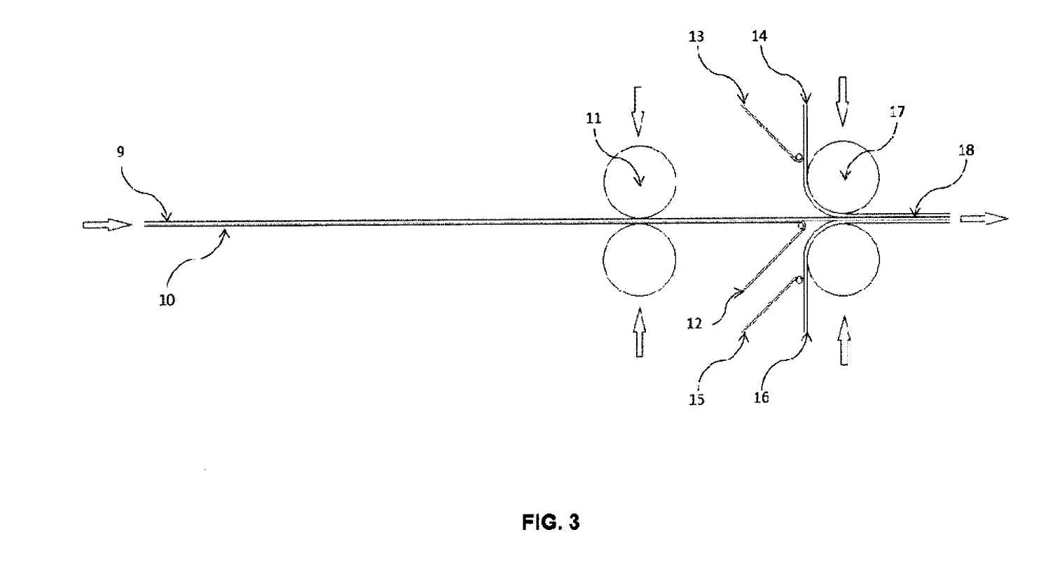

The fabrication scheme displayed in FIG. 1 can encompass the processes outlined in FIG. 2, FIG. 3, and FIG. 4, and may utilize a variety conveyance, devices as part of the prepregging process. However, other variants may be used as part of the multi-stage process to obtain a laminated product.

The first step in the fabrication scheme outlined in FIG. 1 consists of achieving nanomaterial dispersion in an organic and/or inorganic solvent solution. This step starts by utilizing any available nanomaterials, which may be functionalized, in whatever combination or ratio thereof, and incorporates them with an organic and/or inorganic solvent, or a combination or ratio or mixture thereof. Suitable nanomaterials may include Carbon Nanofibers (CNFs), Carbon Nanotubes (CNTs)—including but not limited to Single Wall Carbon Nanotubes (SWCNTs) and Multiwall Carbon Nanotubes (MWCNT's), Nanographenes, Nanographites, Nanodiamond, Nanowiskars, Nanorods, Nanoclays—including Platelet Nanoclays and Tubular Nanoclays, and any other commercial and non-commercial nanomaterial type. Organic solvents may include acetone, ethanol, and others. Inorganic solvents may include water, and others. During such incorporation process, mechanical and/or high shear and/or ultrasonic mixing/dispersion, or a combination thereof, may be employed.

The second step in the fabrication scheme outlined in FIG. 1 consists of taking the nanomaterial dispersion in an organic and/or inorganic solvent solution and conducting a deposition onto a substrate consisting of a support structure and/or reinforcement material. This step may utilize any type of support structure including, but not limited to expanded metal mesh, porous, film-based, or woven fabric substrate of any desired thickness and material constitution or any combination thereof. This step may also utilize a reinforcement material such as a non-woven fabric, woven fabric, or polymer scrim material of any desired thickness and material constitution. The deposition process may utilize a spray technology capable of integrating multiple types of nanomaterials in a multilayer fashion so as to achieve a functionally graded NNWF. The spray technology allows for virtually infinite NNWF width and subsequent length, in or not in roll form.

The third step in the fabrication scheme outlined in FIG. 1 consists of taking the recent nanomaterial deposition and removing the solvent and consolidating the dispersed nanomaterial network. This step may utilize heat, as well as may utilize air flow, in whatever combination or sequence thereof, at whatever evaporation rates so selected.

The fourth step in the fabrication scheme outlined in FIG. 1 consists of two possible outcomes. The first outcome is taking the NNWF with or without the support substrate and forming it into a roll form as a final product, constituting a NNWF in a dry porous roll form (same applies for the case of the NWF). The second outcome is taking the NNWF with or without the support substrate and conducting prepregging on it by one or a combination thereof of three possible methods, resulting in a Nanomaterial based Non-Woven Fabric Prepreg (NNWFP) (same applies for the case of the NWF, resulting in a Nanomaterial based Woven Fabric Prepreg (NWFP)). The three possible methods are displayed in FIG. 2, FIG. 3, and FIG. 4. Additional product versions may include a tow prepreg (most suitable for filament winding applications) and adhesive films.

The first prepregging method consists of infiltration of diluted or non-diluted resin into the NNWF by means of dip-prepregging utilizing any type of resin or combination thereof with or without any type or combination thereof of solvent. Referring to FIG. 2, the NNWF as seen at 1, as it is coming out of the fourth step in the fabrication scheme outlined in FIG. 1, is being conveyed by means of stationary rollers 2 in an arrangement which may resemble that of FIG. 2. The NNWF, as it is moving by its roller-induced conveyance, is submerged and/or dipped in a diluted or non-diluted resin pool 3, which fully or partially infiltrates the NNWF. The newly resin-infiltrated NNWF continues on the roller-induced conveyance which then passes between a set (or sets) of compression rollers 4 which may be heated. Suitable resin systems include but are not limited to Epoxies (Epoxide), Bis-Maleimides (BMI), Phenolics (PF), Polyesters, Vinyl Esters, Polyimides, Polyurethanes (PUR). The resin-infiltrated NNWF, also known as the prepregged NNWF or NNWFP, continues on the conveyance line which then passes the NNWFP between a set of rollers 7 that apply thin release film top 5 and/or bottom 6 sandwiching the prepregged NNWF constituting the final NNWFP product 8, which may be in roll form.

The second prepregging method consists of infiltration of a resin or polymer film into the NNWF by means of roller lamination by taking any type of resin film. Referring to FIG. 3, the NNWF as seen at 9, as it is coming out of the fourth step in the fabrication scheme outlined in FIG. 1 on its support substrate 10, is being conveyed by means of set (or sets) of stationary compression rollers 11, which may be heated, in an arrangement which may resemble that of FIG. 3. The NNWF, as it is moving by its roller-induced conveyance, and after it passes through the set of compression rollers 11, is then separated by its support substrate as seen at 12. The NNWF then continues to pass between a set (or sets) of compression rollers 17, which may be heated, which apply a top 14 and/or bottom 16 resin or polymer film to the NNWF. The resin or polymer films are removed from their inner substrate supports prior to being applied to the NNWF as seen at 13 and 15.

Polymers used in this prepregging process may be either thermosetting polymer or thermoplastic polymer. Suitable thermosetting polymer resin systems include but are not limited to Epoxies (Epoxide), Bis-Maleimides (BMI), Phenolics (PF), Polyesters, Vinyl Esters, Polyimides, Polyurethanes (PUR). Suitable thermoplastic polymers include but are not limited to High Density Polyethylene (HDPE), Low Density Polyethylene (LDPE), Polyvinyl Chloride (PVC), Polypropylene (PP), Polyethylene Terephthalate (PET), Polymethylmethacrylate (PMMA), Polycarbonate (PC), Acrylonitrile Butadiene Styrene (ABS), Polyamide (Nylon 6), Polyimide (PI), Polysulfone (PSF), Polyamide-imide (PAI), Polytetrafluoroethylene (PTFE), Polyetherimide (PEI), Poly ether ketone (PEEK), Polyaryletherketone (PEAK), and Polyphenylene.

The NNWFP 18 that results after 17 may include the outer substrate supports of the resin or polymer films, sandwiching the prepregged NNWF constituting the final NNWFP product, which may be in roll form, if desired.

The third prepregging method consists of infiltration of diluted or non-diluted resin or polymer into the NNWF by means of curtain coating and/or roller lamination utilizing any type of resin or polymer or combination thereof with or without any type of combination thereof of solvent. This method may also include the application of a milled or powdered polymer in place of the diluted or non-diluted resin or polymer. Referring to FIG. 4, the NNWF as seen at 19, as it is coming out of the fourth step in the fabrication scheme on the support substrate 20 outlined in FIG. 1, is being conveyed by means of a set (or sets) of stationary compression rollers 23, which may be heated, which pass the NNWF under a diluted or non-diluted resin or polymer pool or milled or powdered polymer 21, which has a slit along its length and perpendicular to the conveyance direction of the NNWF, which produces a curtain of diluted or non-diluted resin or polymer or milled or powdered polymer 22 that is deposited onto the passing NNWF and subsequently compressed by the set or sets of stationary compression rollers 23.

Polymers used in this prepregging process may be either thermosetting polymer or thermoplastic polymer. Suitable thermosetting polymer resin systems include but are not limited to Epoxies (Epoxide), Bis-Maleimides (BMI), Phenolics (PF), Polyesters, Vinyl Esters, Polyimides, Polyurethanes (PUR). Suitable thermoplastic polymers include but are not limited to High Density Polyethylene (HDPE), Low Density Polyethylene (LDPE), Polyvinyl Chloride (PVC), Polypropylene (PP), Polyethylene Terephthalate (PET), Polymethylmethacrylate (PMMA), Polycarbonate (PC), Acrylonitrile Butadiene Styrene (ABS), Polyamide (Nylon 6), Polyimide (PI), Polysulfone (PSF), Polyamide-imide (PAI), Polytetrafluoroethylene (PTFE), Polyetherimide (PEI), Poly ether ketone (PEEK), Polyaryletherketone (PEAK), and Polyphenylene.

After the NNWF has passed through 23, it continues to a point at which the support substrate from the fourth step in the fabrication scheme outlined in FIG. 1 is then removed 24. The NNWF then continues to pass between a set (or sets) of compression rollers 27, which may be heated, which apply a top 25 and/or bottom 26 release film to the NNWF, sandwiching the prepregged NNWF constituting the final NNWFP 28 product, which may be in roll form.

The double lamination of the prepregging process as depicted in FIG. 4 must involve relatively high pressures and temperatures. Impregnation will not be achieved if normal pressures and temperatures are used. Possible use of a bleeder ply might be necessary to achieve the prosper resin content by allowing the nanomaterial sheet to be created with lower density (higher porosity) to allow the resin to more easily flow and infuse the nanoparticle sheet. Then, the impregnated sheet is passed through heated rollers to release excess resin content, yielding a properly impregnated nanoparticle sheet. This is a technique that is not used conventionally.

Without the immediate application of one or a combination of all three prepregging techniques to the freshly consolidated nanoparticle structure, prepregging of the nanoparticle structure could not occur. Even the prepregged nanoparticle sheet is still relatively fragile. Consequently, the lamination of the prepregged nanoparticle sheet with other products must be accomplished as soon as possible upon the drying of the resin from the prepregging. Such products are described below with respect to FIG. 5-25. Because these products include a prepregged nanoparticle element, they constitute new products. These new products will be used in a variety of different applications from aircraft panels, to insulation structures, to EMF shielding, to communication control structures. All of these products can be created as part as one fully integrated process, without which the final product could be compromised do to the comprising of the nanoparticle structures.

The NNWF and or the NWF and or the NNWFP materials may take form in a variety of configurations and laminate schedules, where they may or may not be the only component or constituent in the final standalone prepreg. Depending on the desired performance target, and the inherent application where the final standalone prepreg will be placed, one particular configuration will be more favorable over the other possible configurations, i.e., an optimum tailored configuration specific to a particular use with selected constituents. FIG. 5 through 21 illustrate the major possible configurations and laminate schedules which may constitute a final standalone prepreg.

FIG. 5 illustrates a prepregged nanoparticle product with the primary constituent being the NNWF or the NWF, with or without a support scrim, in addition to the resin matrix. The resin matrix may or may not contain dispersed nanoparticles and particular chemical functionalization. Such prepreg 29 should be considered a standalone prepreg.

FIG. 6 illustrates a prepreg whose constituents are those of 29 in addition to an Electrical and/or Thermal Insulator (ETI) 30. ETI may include, but are not limited to, fiber reinforcements, polymer films, porous cellulose films, or other NNWF. Such prepreg and its specific laminate schedule shall be considered a standalone prepreg.

FIG. 8 illustrates a prepreg whose constituents are those of 29, in addition to an Expanded Metal Mesh (EMM) 31. EMM includes those comprising any metal and or metallic alloy. Such prepreg and its specific laminate schedule shall be considered a standalone prepreg.

FIG. 10 illustrates a prepreg whose constituents are those of 29, with 30, and an EMM in bus bar shape and function 32. Such prepreg and its specific laminate schedule shall be considered a standalone prepreg. The integration of an EMM within a prepreg facilitates the transfer of electricity from an arbitrary source to the conductive prepreg, thus enabling heating capacity and or grounding.

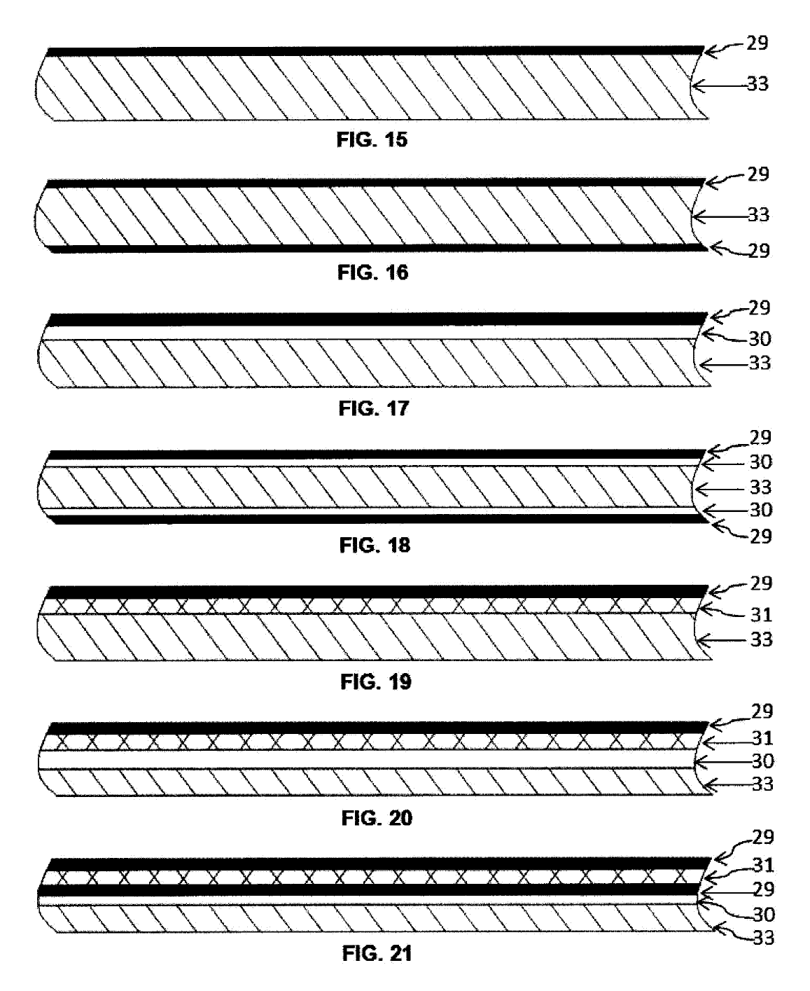

FIG. 15 illustrates a prepreg whose constituents are those of 29, in addition to a Fiber Reinforcement (FR) 33. FR may include, but is not limited to, glass fiber reinforcements, carbon fiber reinforcements, and aramid fiber reinforcements. Such prepreg and its specific laminate schedule should be considered a standalone prepreg. The reinforcing fibers are preferably added after the prepregging process so that better adhesion between the prepregged nanoparticle sheet 29 an fiber reinforcement 33 is achieved.

FIGS. 7, 9, 11, 12, 13, 14, 16, 17, 18, 19, 20, and 21 are also each and every one a standalone prepreg with a specific laminate schedule and previously described constituents utilized in various configurations for specific applications.

FIG. 22 illustrates the use of any of the standalone prepregs (mentioned earlier and illustrated in FIG. 5 through FIG. 21) 34, in conjunction with any kind of Load Bearing (or primary) Reinforcement (herein referred to as LBR) 33. LBRs may include, but are not limited to, fiber reinforcements (woven and/or non-woven and/or stitched and/or non-stitched, in any direction), fabrics (woven and/or non-woven and/or stitched and/or non-stitched, in any direction), and prepregs. Such composite and its specific configuration shall be considered a standalone composite.

FIGS. 23, 24, and 25 illustrate other configurations utilizing constituents 33 and 34. Each and every one is a standalone composite with a specific configuration and utility. These configurations should also serve to illustrate that a laminate schedule with alternating sequence between constituents 33 and 34 amongst the entirety of the thickness of the material is also described.

FIG. 26 depicts a system for continuously carrying out the nanoparticle sheet spraying deposition, which is the first portion of the integrated process that includes prepregging and lamination. It should be understood that FIG. 26 refers to one system for carrying out the process of the present invention. This system is novel as a whole although it uses a number standard components. Nonetheless to carry out the aforementioned process, these components must be modified for use in this particular system. Of all of the components included in the aforementioned composite laminate examples, few are conventionally used in any connection to nanoparticle structures, or their manufacture.

While FIG. 26 depicts only a segment of the continuous manufacturing system, in a manner similar to the segments of the system depicted in FIGS. 2, 3, and 4, this is done only for full understanding that certain segments of the continuous manufacturing process are novel in of themselves. FIG. 26 depicts the “front end” of the continuous processing system. This portion of the system provides a novel technique for forming large nanoparticle sheets.

The first component of the continuous nanomaterial desperation and spray deposition recirculation system is the solution reservoir 52. This is constituted primarily by an inlet 51, and an electric or pneumatic motor which drives a propeller type shear mixing shaft 53, housed within the subject reservoir.

Inlet 51 is crucial in that it completes a continuous recirculation of the entire system after the dispersed material goes through a diverting outlet 79, if it has not been distributed by atomizing spray nozzle 78. The flow from diverting outlet 79 goes back into inlet 1 to complete the cycle. This is crucial for the continuous operation of the present system. This aspect of the system is novel with regard to the manufacture of nanomaterials structures.

After the first mixing stage, the suspended nanomaterial flows into a peristaltic pump 54, which constitutes the second component of the system. This pump is constituted primarily by a set of rollers for the forced positive displacement of the fluid suspension housed in a looped flexible chemically resistant tube 55. While the mixing of nanoparticle solutions are well known in the conventional art, this particular technique has not been used.

Upon exiting the peristaltic pump the displaced fluid continues to flow into the third component of the system, a hydraulic pressure damper, through inlet 56 which measures a higher pressure set point than outlet 57 of the hydraulic pressure damper. This hydraulic pressure damper is also constituted by an electric or pneumatic motor 59 which drive a propeller type shear mixing shaft 70, which is housed within the reservoir of the hydraulic pressure damper. The hydraulic pressure damper also includes an inlet valve 58 that introduces compressed air into the damper. This inlet valve has a pressure set point below that of inlet 56 and higher than that of outlet 57.

After the fluid suspension exits the hydraulic pressure damper via outlet 57, it flows into the ultrasonic flow cell via inlet 71 into the sonication flow cell 75. At this point, the transducer horn 16 creates cavitations, disrupting and dispersing any solid material conglomerates into individual nanomaterial particles within a suspension. The transducer horn 76 is powered by an ultrasonic generator 77, and is temperature regulated by the flow of liquid coolant which is introduced via inlet 73, and extracted via outlet 74 in a continuous recirculating manner. The fully dispersed nanomaterial suspension moves to the sonication stage, which constitutes the fourth component of the system, via outlet 72.

From outlet 72, the fully dispersed nanomaterial suspension flows into the fifth component of the system, the recirculating atomizing spray nozzle array 78. Here the fully dispersed nanomaterial suspension is sprayed and deposited on an appropriate receptor (not shown). When the spray nozzle array 78 is not engaged, the fully dispersed nanomaterial suspension continues to flow through outlet 79 and back into inlet 51. This continuous operation is not found in any known nanoparticle manufacturing or deposition technique.

It should be understood that the use of sonication in the aforementioned system is a critical step in dispersing solid materials into liquids. This is especially clear when the materials desired to be dispersed are in a micrometer or nanometer range. The materials to be dispersed, such as nanomaterial, are normally held together by attractive forces such as Vander Waals forces and physical entanglement. Once nanomaterial is introduced in the solvent, they are dispersed to form a semi-homogeneous solution by means of mechanical stirring, and or, high shear mixing. Once nanomaterial is dispersed to the point where there are no agglomerates larger than one millimeter, the solution is in fluid to an ultrasonic flow cell. The flow cell exposes the solutions to an ultrasonic transducer horn or tip which creates cavitation in the solution forcing any conglomerates in dispersing into individual particles within a solution.

The process variables that affect dispersion and particle size are the frequency and vibrations used, as well as the amplitude of the waves being used. These variables are adjusted based on these specific nanomaterial used and the desired characteristics of the final nanoparticle structure. Examples of sonication devices that could be used in the present system of those manufactured by Hielscher Ultrasonic GmbH or Branson (in particular to the ultrasonic device product line from Emerson Industrial Automation).

The solution reservoir 52 is also referred to as a mixing tank. This mixing tank is constructed of stainless steel which is resistant to organic solvents used to disperse nanomaterial in the inventive process. The mixing tank has an inlet valve 51 at the top of the tank allows the introduction of solvent or solution into the tank. The tank also has a second dispersing valve at the bottom of the tank for delivering solvent or solution to the next component in the industrial process. The other part of the mixing tank is an electrical agitator with various speeds, which maintains the undispersed materials in suspension. Examples of this kind of components would be mixing tanks manufactures from Walther Pilot North America.

The peristaltic pump is a type of positive displacement pump which uses a flexible tube contained within a circular pump casing which is compressed by a roller in a revolving fashion, forcing fluid through the flexible tube and creating flow. This kind of positive displacement pump allows the solution to never come in contact with any complex geometrical element, as of those found in conventional pumps. Such contact when using nanoparticles could lead to filing or clogging of conventional pumps. Peristaltic pumps are also used when the solution to be displaced are corrosive or dangerous in nature. This peristaltic pump will flow the solution to the pressurized mixing tank at pressure between 10 and 80 psi. Examples of this type of pump are manufactured by Graco.

The hydraulic pressure damper is generally known as a pressurized mixing tank. This is similar in nature to the regular mixing tanks except that it has the capability to pressurized between 5 and 60 pounds per square inch. This pressure allows incoming fluid from the peristaltic pump to be introduced to the tank while also pressurizing the fluid within the tank and forcing it to flow to the ultrasonic flow cell downstream. Components such as this are manufactured by Walther Pilot North America.

The recirculating atomizing spray nozzle can be adjusted for high pressure and low volume or high volume and low pressure. A variety of different nozzles can be used within the concept of the present invention, depending upon the thickness of the nanomaterial deposition, and the particular type of nanomaterial being used. Of course, for the present invention the recirculating atomizing spray nozzle is modified with the addition of a special front body with both a material supply inlet as well as a material recirculation or material outlet. The basic unmodified nozzle can be obtained by Walther Pilot North America.

It is crucial that aspects of the combined process (spray depositing a nanoparticle sheet and prepregging that sheet) be performed at the same location to minimize damage to both the bare nanoparticle sheet and the prepregged nanoparticle sheet. Once the nanomaterial is deposited on an appropriate backing scrim, substrate, support or carrier, the carrier is conveyed directly to a point to be infused or impregnated with resin. This is done to minimize handling, and as a result imposing very little mechanical force on the bare nanomaterial sheet. This arrangement allows the sheet to be well expanded and to exhibit a very low bulk density and a very high porosity. This in turn results in more effective infusion of the resin into the sheet.

If the use of binders or resins in the nanomaterial solution (such as is done in the Armeniades et.al patent) is avoided, the nanomaterial can be consolidated while simultaneously removing the solvent by evaporation or drying. This greatly accelerates the overall inventive process over that of the Armeniades et.al patent. Further, this also assures the desired level of porosity in the nanoparticle sheet.

There is a distinct difference between the final product of the Armeniades et al. patent, as depicted in FIG. 27 and the new product resulting from the present inventive system (partially depicted in FIG. 26). It should be noted that the Armeniades et al. patent uses resins within the nanoparticle solution. The result is that resins coat each of the nanoparticles 81 (as depicted in FIG. 27) in the resulting structure of Armeniades et al. This means that the intersection 84 between two nanoparticles 81 will be insulated from each other by a double resin coating 82 from the overall resin matrix 83. This means that electrical conductivity between nanoparticles 81 will be very much reduced, thereby eliminating the product of Armeniades et al. from many types of applications in which electrical conductivity is desirable.

In contrast, there are no resins used in the nanoparticle solution of the present invention. Rather, the nanoparticle spray is deposited, solvents evaporated, and the nanoparticles fully consolidated before resin is added as part of a prepregging process. This is illustrated in FIG. 28, wherein nanoparticles 81 are in direct contact with each other at intersection 83 while the entire complex of nanoparticles 81 is contained within resin matrix 82. This structure allows electrical conductivity for the nanoparticle sheet (29 in FIG. 5). As a result, the prepregged nanoparticle sheet 29 is suitable for many applications that require electrical conductivity. Such applications include lightening protection, and various communication arrangements.

The result of the present invention is found in FIG. 28, in which the nanoparticles are in contact with each other, despite the high level of precocity of the final product (between 30% and 70%). This means that the new product produced by the present inventive system creates a much better level of conductivity then that possible with the product of Armeniades et al. Consequently, the product depicted in FIG. 28 can be used in panels where high conductivity is considered desirable.

Because the present inventive system uses spray deposition from an atomizing spray 18 (or its equivalent), the present invention is scalable. For example, sprays with wider distribution or multiple spray heads can be used to create larger nanoparticle sheets. These sheets in turn can be immediately prepregged with a spray (or other type of application) of resin, once the nanoparticles are fully consolidated and the solvents evaporated. The spray deposition of the nanoparticle sheets allows for very thin, highly porous (“fluffy”) structures.

This arrangement also facilitates the use of multiple films or sheets of nanoparticle material piled on each other, either with or without the prepregging of each nanoparticle sheet or film. All that is necessary is either that the spray head moves in a sweeping pattern, or the bed supporting the nanoparticle sheet move in the same fashion. Further, the combined movement of both is also possible to facilitate more rapid deposition of multiple nanoparticle sheets or films. The prepregging operation can also be combined so that a nanoparticle sheet is made using spray deposition and immediately prepregged once the solvents have evaporated. The key to this is having the prepregging operation at or very close to the location of the nanoparticle deposition sprayer.

Once the fully consolidated nanoparticle structure is prepregged, it is best to immediately continue with the lamination process using other materials. This takes advantage of the fresh prepregging to serve as an adhesive without the addition of further resin which could compromise the final nanoparticle structure by leaving too much resin in the overall laminated product. The consolidation of all three sub-routines (deposition of the nanoparticle sheet or structure, prepregging of the nanoparticle structure, and lamination of the freshly prepregged nanoparticle structure) is crucial to maximum efficiency and to maintaining the final product at the correct constitution of resin in relationship to other materials. It also protects the product by limiting movement and handling until the final laminated product is ready to be applied to its final purpose.

Many of the advantages of the present invention come from the use of spray deposition using a continuous dispersion process, aided by sonication. The use of continuous dispersion means that the limitations and drawbacks of batch processing are avoided. In particular, agglomeration of nanoparticle materials, which occurs in conventional processes, is avoided.

In contrast, conventional methods of making nanoparticle sheets include the suspension filtration method. This method is based on dispersing nanoparticles in solvent, then flowing the suspension through a filter or porous membrane, depositing nanoparticles on the membrane in order to produce the sheet. Another traditional technique is the “paper making process” in which nanoparticles are suspended in a solvent or liquid. This is followed by a straining process to deposit the nanoparticles onto a screen or mesh to create the sheet. The carbon vapor deposition process consists of directly growing nanoparticle material on a carbon vapor deposition reactor. The material is then deposited onto a conveyer-type system and flattened to create a sheet.

Only the present inventive system uses spray deposition. The result is the capability of making very thin, very porous nanoparticle structures, easily creating multi-layer structures, controlling the amount of prepregging resin applied, as well as the types of materials used in the prepregging and the individual nanoparticle films. The present invention also avoids difficulties in handling the nanoparticle sheets, and further allows for the perfect combination of tensile strength and precocity to facilitate the prepregging process. Further, since the binder (normally used to strengthen the nanoparticle structure for handling) can be removed from the inventive process, the precision and effectiveness of the prepregging process is enhanced, thereby enhancing the final product.

It should be clear that a wide range of variations can be applied to the inventive system, process and final product. Because the nanoparticle sheets of the present invention constitute unique products not found in other nanoparticle processes, any product, such as a laminate with other materials, that includes the products made by the inventive process and system, are also novel.

While many embodiments of the present invention have been made by way of example, the present invention is not limited thereto. Rather, the present invention should be understood to include any and all variations, permutations, modifications, adaptations, derivations and embodiments that would occur to one skilled in this technology, and having possession of the teachings of the present invention. Consequently, the present invention should be construed as being limited only by the following claims.

We claim:

1. A composite structure comprising:
a. at least one prepregged nanoparticle structure, wherein resin is infused in and around said nanoparticle structure, and individual nanoparticles maintain contact with each other within a resin matrix.

2. The composite structure of claim 1, wherein said nanoparticle structure is a sheet.

3. The composite structure of claim 2, wherein said nanoparticle sheet is non-woven.

4. The composite structure of claim 3, further comprising a backing upon which said non-woven nanoparticle sheet is supported.

5. The composite structure of claim 4, wherein said backing consists of one or a combination of the following: non-woven fiber films, polymer scrims, expanded metal mesh, woven fiber sheets, stitched fiber sheets, unidirectional fiber sheets, cellulous paper, and polymer films.

6. The composite structure claim 1, wherein said resin comprises at least one selected from a group consisting of thermoset resins and thermoplastic polymers.

7. The composite structure of claim 5, further comprising at least one additional nanoparticle sheet, arranged on said prepregged nanoparticle sheet.

8. The composite structure of claim 7, wherein said additional nanoparticle sheet is prepregged.

9. The composite structure of claim 8, further comprising at least one additional resin layer.

10. The composite structure of claim 9, further comprising at least one metal layer.

11. The composite structure of claim 10, wherein said at least one metal layer comprises expanded metal mesh.

12. The composite structure of claim 10, further comprising at least one plastic layer.

13. The composite structure of claim 12, further comprising at least one thermoinsulating layer.

14. The composite structure of claim 13, further comprising at least one fiber layer.

15. A process for manufacturing a nanoparticle structure, said process comprising the steps of:
a. forming a nanoparticle dispersion in a solvent;
b. depositing at least a portion of said nanoparticle dispersion on a support structure; and,
c. removing solvent from said deposited portion of said nanoparticle dispersion to form a nanoparticle structure on said support structure.

16. The process of claim 15, further comprising the step of:
d. consolidating said deposited nanoparticle on said support structure.

17. The process of claim 16, wherein a part of said nanoparticle dispersion not deposited constantly recirculates to a mixing system for forming said nanoparticle dispersion.

18. The process of claim 17, wherein said nanoparticle dispersion deposited on said support structure comprises a sheet of nanoparticle material.

19. The process of claim 18, further comprising the steps of forming at least one additional nanoparticle sheet on a first nanoparticle sheet formed on said support structure.

20. The process of claim 19, wherein said step of depositing said nanoparticle dispersion comprises atomizing and spraying said nanoparticle dispersion being deposited.

21. The process of claim 20, wherein said step of forming said nanoparticle dispersion comprises ultrasonic mixing.

22. The process of claim 21, wherein said step of forming said nanoparticle dispersion further comprises the sub-step of hydraulic damping.

23. A method of prepregging a nanoparticle structure, comprising:
a. forming a finished nanoparticle structure; and impregnating said finished nanoparticle structure with at least one of a group consisting of resin and polymers.

24. A method of claim 23, wherein said nanoparticle structure is a sheet.

25. The method of claim 24, wherein said nanoparticle sheet is non-woven.

26. The method of claim 25, wherein said non-woven nanoparticle sheet is arranged on a support structure.

27. The method of claim 26, wherein step (b) of impregnating is accomplished by dipping said non-woven nanoparticle sheet in a resin reservoir.

28. The method of claim 25, wherein step (b) of impregnating of said non-woven nanoparticle sheet comprises the operation of spraying resin on at least one side of said non-woven nanoparticle sheet.

29. The method of claim 26, wherein step (b) of impregnating comprises placing a resin layer on one side of said non-woven nanoparticle sheet.

30. The method of claim 29, wherein step (b) of impregnating further comprises the substep of placing a resin layer on both sides of said non-woven nanoparticle sheet.

31. The method of claim 30, wherein both said resin layers are forced against said non-woven nanoparticle sheet by heated rollers.

32. A system for manufacturing nanoparticle structures comprising:
a. at least one mixing portion to produce a dispersion of nanoparticles in a solvent;
b. a spraying device for depositing a portion of said dispersion of nanoparticles and solvent on an external support; and,
c. a recirculating system connected from said spraying device to said at least one mixing device and configured to return a portion of said nanoparticle dispersion which is not deposited.

33. The system of claim 32, further comprising an ultrasonic mixer capable of creating cavitations.

34. The system of claim 33, further comprising a second mixing portion having a peristaltic pump.

35. The system of claim 34, wherein said spraying device is an atomizer sprayer.

36. The system of claim 35, further comprising a hydraulic pressure damper to downstream from ultrasonic mixer.
